(19) United States
(12) Patent Application Publication
(10) Pub. No.: US 2005/0039995 A1
(43) Pub. Date: Feb. 24, 2005

(54) Shock absorbing apparatus for internal unit

(75) Inventors: Misao Inoke, Kawasaki (JP); Rikako Shinomiya, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/956,602

(22) Filed: Oct. 1, 2004

Related U.S. Application Data
(63) Continuation of application No. PCT/JP02/05417, filed on Jun. 3, 2002.

(51) Int. Cl. F16F 7/12

(52) U.S. Cl. 188/371

(57) ABSTRACT

When an impact acts on a shock absorbing apparatus from the side of a first slide member, the reaction of the impact drives an internal unit toward the first slide member. The elastic deformation is induced in the first elastic member. The elastic deformation of the first elastic member causes the first slide member to slide on the wall surface of the receiving space. The displacement of the first slide member is transmitted to the second slide member through the coupling member. The second slide member is caused to move along the wall surface of the receiving space. The displacement of the second slide member induces elastic deformation of the second elastic member. The entire shock absorbing apparatus serves to consume the kinetic energy of the impact. Only a reduced impact reaches the internal unit.

### BACKGROUND OF THE INVENTION

1. Field of the Invention

The present invention relates to a shock absorbing apparatus attached to an internal unit so as to improve shockproof of the internal unit. In particular, the invention relates to a shock absorbing apparatus utilized when an internal unit such as a hard disk drive (HDD) is assembled into an electronic apparatus such as a notebook personal computer, for example.

2. Description of the Prior Art

A hard disk drive unit is incorporated within a predetermined inner space of a notebook personal computer, for example. A shock absorbing member is interposed between the hard disk drive unit and the wall surrounding the inner space. The shock absorbing member is usually formed from an elastic material such as solid rubber and sponge rubber. When the notebook personal computer is dropped on the ground or the like, a larger impact is applied to the enclosure of the notebook personal computer. The shock absorbing member is expected to absorb the impact. The hard disk drive unit can be protected from the impact.

It is preferable to reduce the volume of the inner space. A reduced volume of the inner space leads to a further reduction in the size of the notebook personal computer. However, a reduced volume of the inner space induces a reduced space between the hard disk drive unit and the wall surrounding the inner space. The thickness of the shock absorbing member must be reduced. Reduction in the thickness of the shock absorbing member induces a reduced performance of the shock absorbing member.

### SUMMARY OF THE INVENTION

It is accordingly an object of the present invention to provide a shock absorbing apparatus, for an internal unit, capable of absorbing an impact of a sufficient intensity within a limited space.

According to a first aspect of the present invention, there is provided a shock absorbing apparatus for an internal unit, comprising: first and second contact members holding the internal unit therebetween; a first slide member located at a position spaced from the outer surface of the internal unit, said first slide member coupled to the first contact member through a first elastic member; a second slide member located at a position spaced from the outer surface of the internal unit, said second slide member coupled to the second contact member through a second elastic member; and a coupling member coupling the first and second slide members with each other.

The shock absorbing apparatus is mounted on the internal unit. The internal unit is held between the first and second contact members. The internal unit is placed within a receiving space along with the shock absorbing apparatus. The first slide member is received on the wall surface of the receiving space. The first elastic member exhibits an elasticity distancing the internal unit away from the wall surface of the receiving space. The second slide member is likewise received on the wall surface of the receiving space on the opposite side of the internal unit. The second elastic member exhibits an elasticity distancing the internal unit away from the wall surface of the receiving space. In this manner, the internal unit is received within the receiving space without contacting the wall surface of the receiving space.

Now, assume that an impact acts on the shock absorbing apparatus from the side of the second slide member, for example. The reaction of the impact drives the internal unit toward the second slide member. A space is reduced between the outer surface of the internal unit and the wall surface of the receiving space near the second slide member. The elastic deformation is induced in the second elastic member to store the elasticity. This elastic deformation serves to consume the kinetic energy of the impact. The second contact member is displaced toward the second slide member. The second contact member keeps contacting the internal unit during the displacement.

The elastic deformation of the second elastic member causes the second slide member to slide on the wall surface of the receiving space. The movement of the second slide member serves to consume the kinetic energy of the impact. The kinetic energy of the impact is also consumed in the friction during the movement of the second slide member. The displacement of the second slide member is transmitted to the first slide member through the coupling member. The first slide member is caused to slide on the wall surface of the receiving space. The kinetic energy of the impact is consumed in the movement of the first slide member as well as in the friction during the movement of the first slide member.

The displacement of the first slide member causes the first elastic member to elastically deform. The first elastic member is allowed to generate a driving force to distance the first contact member away from the wall surface of the receiving space. The first contact member thus follows the movement of the internal unit. The first contact member keeps contacting the internal unit irrespective of the displacement of the internal unit. The kinetic energy of the impact is thus consumed in the elastic deformation of the first elastic member. In this manner, the entire shock absorbing apparatus serves to consume the kinetic energy of the impact, so that the impact is remarkably attenuated in a shorter duration before reaching the internal unit. The internal unit is thus sufficiently protected from the impact.

When an impact acts on the shock absorbing apparatus from the side of the first slide member, the reaction of the impact drives the internal unit toward the first slide member. A space is reduced between the outer surface of the internal unit and the wall surface of the receiving space near the first slide member. The elastic deformation is induced in the first elastic member to store the elasticity. The elastic deformation of the first elastic member causes the first slide member to slide on the wall surface of the receiving space. The displacement of the first slide member is transmitted to the second slide member through the coupling member. The second slide member is caused to move along the wall surface of the receiving space. The displacement of the second slide member induces elastic deformation of the second elastic member. In this manner, the entire shock absorbing apparatus serves to consume the kinetic energy of the impact. Only a reduced impact reaches the internal unit in the same manner as described above.

The first and second contact members, the first and second elastic members, the first and second slide members and the coupling member may be formed from a common material. Specifically, the first and second contact members, the first and second elastic members, the first and second slide members and the coupling member may be made of a continuous metallic plate. The first and second contact members, the first and second elastic members, the first and second slide members and the coupling member preferably cooperate to surround the internal unit. In this case, the first and second contact members, the first and second elastic members, the first and second slide members and the coupling member may be made of a continuous metallic plate.

According to a second aspect of the present invention, there is provided a shock absorbing apparatus for an internal unit, comprising: first and second contact members holding the internal unit therebetween; a first elastic member extending from the first contact member in a first direction; a first slide member located at a position spaced from the outer surface of the internal unit, said first slide member coupled to the first elastic member; a second elastic member extending from the first contact member in a second direction opposite to the first direction; a second slide member located at a position spaced from the outer surface of the internal unit, said second slide member coupled to the second elastic member; a third elastic member extending from the second contact member in the first direction; a third slide member located at a position spaced from the outer surface of the internal unit, said third slide member coupled to the third elastic member; a fourth elastic member extending from the second contact member in the second direction; a fourth slide member located at a position spaced from the outer surface of the internal unit, said fourth slide member coupled to the fourth elastic member; a first coupling member coupling the first and third slide members with each other; and a second coupling member coupling the second and fourth slide members with each other.

The shock absorbing apparatus is mounted on the internal unit. The internal unit is held between the first and second contact members. The internal unit is placed within a receiving space along with the shock absorbing apparatus. The first and second slide members are received on the wall surface of the receiving space. The first and second elastic members exhibit an elasticity distancing the internal unit away from the wall surface of the receiving space. The third and fourth slide members are likewise received on the wall surface of the receiving space on the opposite side of the internal unit. The third and fourth elastic members exhibit an elasticity distancing the internal unit away from the wall surface of the receiving space. In this manner, the internal unit is received within the receiving space without contacting the wall surface of the receiving space.

Now, assume that an impact acts on the shock absorbing apparatus from the side of the third and fourth slide members, for example. The reaction of the impact drives the internal unit toward the third and fourth slide members. A space is reduced between the outer surface of the internal unit and the wall surface of the receiving space near the third and fourth slide members. The elastic deformation is induced in the third and fourth elastic members to store the elasticity. This elastic deformation serves to consume the kinetic energy of the impact. The second contact member is displaced toward the third and fourth slide members. The second contact member keeps contacting the internal unit during the displacement.

The elastic deformation of the third and fourth elastic members causes the third and fourth slide members to slide on the wall surface of the receiving space. The third and fourth slide members get distanced from each other. The movement of the third and fourth slide members serves to consume the kinetic energy of the impact. The kinetic energy of the impact is also consumed in the friction during the movement of the third and fourth slide members. The displacement of the third slide member is transmitted to the first slide member through the first coupling member. The first slide member is caused to slide on the wall surface of the receiving space. The displacement of the fourth slide member is likewise transmitted to the second slide member through the second coupling member. The second slide member is caused to slide on the wall surface of the receiving space. The kinetic energy of the impact is consumed in the movement of the first and second slide members as well as in the friction during the movement of the first and second slide members.

The first and second slide members get closer to each other, so that the first and second elastic members are caused to elastically deform in response to the displacement of the first and second slide members. The first and second elastic members serve to generate a driving force to distance the first contact member from the wall surface of the receiving space. The first contact member is thus allowed to follow the movement of the internal unit. The first contact member keeps contacting the internal unit irrespective of the displacement of the internal unit. The kinetic energy of the impact is consumed in the elastic deformation of the first and second elastic members. In this manner, the entire shock absorbing apparatus serves to consume the kinetic energy of the impact, so that the impact is remarkably attenuated in a shorter duration before reaching the internal unit. The internal unit is thus sufficiently protected from the impact.

When an impact acts on the shock absorbing apparatus from the side of the first and second slide members, the reaction of the impact drives the internal unit toward the first and second slide members. A space is reduced between the outer surface of the internal unit and the wall surface of the receiving space near the first and second slide members. The elastic deformation is induced in the first and second elastic members to store the elasticity. The elastic deformation of the first and second elastic members causes the first and second slide members to slide on the wall surface of the receiving space. The first and second slide members get distanced from each other. The displacement of the first and second slide members is transmitted to the third and fourth slide members through the first and second coupling members. The third and fourth slide members are caused to slide on the wall surface of the receiving space. The third and fourth slide members get closer to each other, so that the third and fourth elastic members are caused to elastically deform in response to the displacement of the third and fourth slide members. In this manner, the entire shock absorbing apparatus serves to consume the kinetic energy of the impact. Only a reduced impact reaches the internal unit in the same manner as described above.

The first and second contact members, the first, second, third and fourth elastic members, the first, second, third and fourth slide members and the first and second coupling members may be formed from a common material. Specifically, the first and second contact members, the first, second, third and fourth elastic members, the first, second, third and fourth slide members and the first and second coupling members may be made of a continuous metallic plate. The first and second contact members, the first, second, third and fourth elastic members, the first, second, third and fourth slide members and the first and second coupling members preferably cooperate to surround the internal unit. In this case, the first and second contact members, the first, second, third and fourth elastic members, the first, second, third and fourth slide members and the first and second coupling members may be made of a continuous metallic plate.

The aforementioned receiving space may be defined in an enclosure of an apparatus accepting the insertion of the internal unit, in an enclosure unique to the shock absorbing apparatus, or the like. The enclosure unique to the shock absorbing apparatus may contain the shock absorbing apparatus along with the internal unit so as to establish an assembly. The assembly of the type is expected to realize easy handling of the shock absorbing apparatus and the internal unit.

The shock absorbing apparatus may be utilized for an internal unit such as a hard disk drive (HDD) unit incorporated within an electronic apparatus including a notebook personal computer, a personal digital assistance (PDA), and the like. Otherwise, the shock absorbing apparatus may be utilized in any types of apparatus other than the electronic apparatus.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating a notebook personal computer as a specific example of an electronic apparatus;

FIG. 2 is an enlarged perspective view of a hard disk drive (HDD) unit incorporated in a main equipment of the notebook personal computer;

FIG. 3 is an enlarged vertical sectional view taken along the line 3-3 in FIG. 2;

FIG. 4 is an enlarged vertical sectional view schematically illustrating the action of a shock absorbing apparatus;

FIG. 5 is a schematic view illustrating a half exemplified model of the shock absorbing apparatus;

FIG. 6 is a graph illustrating the result of a computer-implemented simulation based on the exemplified model;

FIG. 7 is a graph illustrating the result of the computer-implemented simulation based on a first comparative model;

FIG. 8 is a graph illustrating the result of the computer-implemented simulation based on a second comparative model;

FIG. 9 is a graph illustrating the relationship between measurement and the result of the computer-implemented simulation;

FIG. 10 is a graph illustrating the vibration characteristic of the exemplified and first comparative models;

FIG. 11 is a perspective view schematically illustrating a shock absorbing apparatus according to a modification;

FIG. 12 is a perspective view schematically illustrating a shock absorbing apparatus according to another modification;

FIG. 13 is a perspective view schematically illustrating a shock absorbing apparatus according to a further modification; and

FIG. 14 is a perspective view schematically illustrating a shock absorbing apparatus according to a still further modification.

### DESCRIPTION OF THE PREFERRED EMBODIMENTS

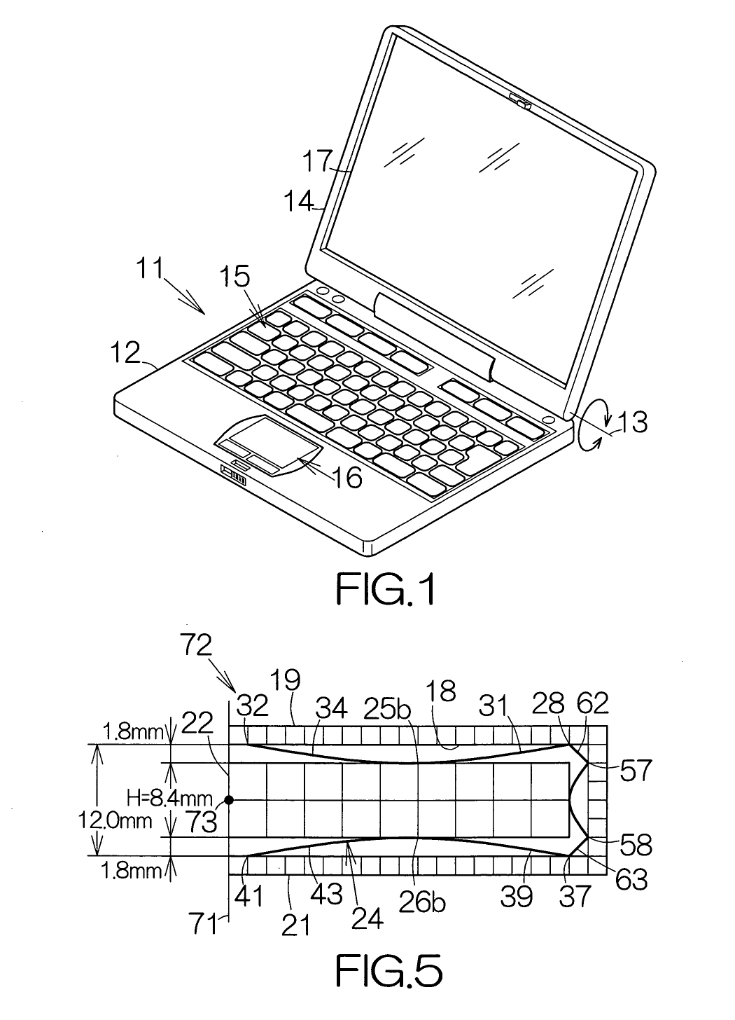

FIG. 1 schematically illustrates a notebook personal computer 11 as a specific example of an electronic apparatus. The notebook personal computer 11 includes a main equipment 12 and a display enclosure 14 coupled to the main equipment 12 for swinging movement around an axis 13. A motherboard, not shown, is incorporated within an enclosure of the main equipment 12. As conventionally known, a central processing unit (CPU), a memory, and the like, are mounted on the motherboard, for example. The CPU is allowed to operate based on an operating system (OS) as well as application softwares temporarily stored in the memory, for example. The user can input various data and instructions through input devices such as a keyboard 15 and a pointing device 16 mounted on the main equipment 12. A liquid crystal display (LCD) unit 17 is incorporated within the display enclosure 14. Graphics and/or texts are displayed on the screen of the liquid crystal display unit 17.

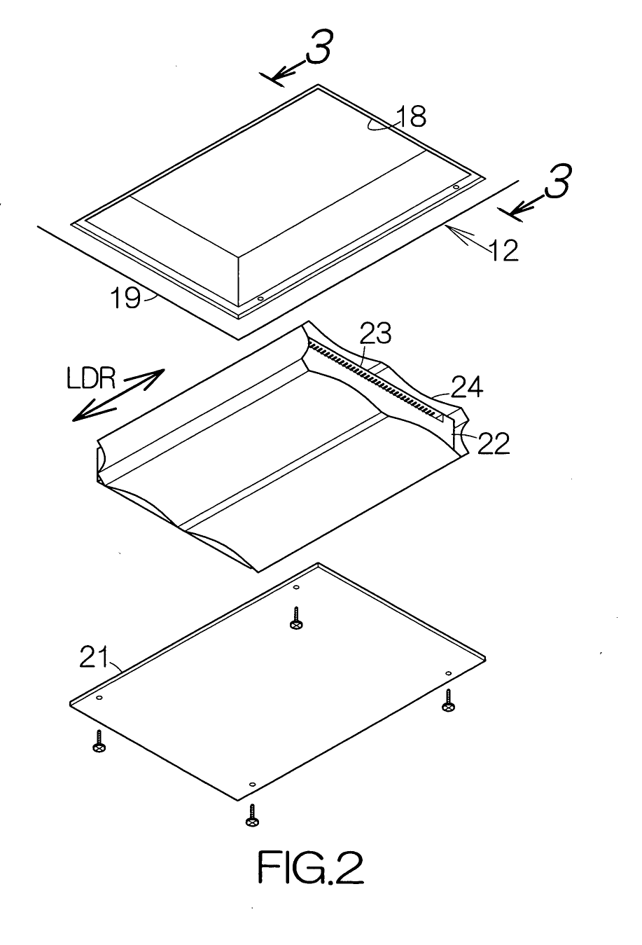

As shown in FIG. 2, the enclosure of the main equipment 12 includes an enclosure body 19 defining a receiving space 18. A cover 21 is attached to the enclosure body 19 so as to close the opening of the receiving space 18. The receiving space 18 may open at the back or bottom of the main equipment 12, for example. When the notebook personal computer 11 is placed on the desk or the like, the opening of the receiving space 18 at the bottom of the main equipment 12 is opposed to the surface of the desk. The enclosure body 19 and/or the cover 21 may be made from a metallic material such as aluminum, magnesium, or the like, and/or a plastic material such as a fiber reinforced plastic (FRP). Molding process may be employed to form the enclosure body 19 and/or the cover 21 in this case. Screws may be employed to fix the cover 21 on the enclosure body 19, for example.

A hard disk drive (HDD) unit 22 as a specific example of an internal unit is incorporated in the enclosure body 19. The hard disk drive unit 22 is received in the receiving space 18. A connector 23 is assembled in the hard disk drive unit 22 at the front end thereof in the longitudinal direction LDR of the hard disk drive unit 22. The connector 23 may be mounted on a printed circuit board, not shown, coupled to the front or upper surface of the hard disk drive unit 22. The connector 23 is connected to a flexible cable, not shown, extending from the motherboard incorporated within the main equipment 12, for example.

The shock absorbing apparatus 24 is designed to continuously surround the hard disk unit 22 without a gap. Here, the shock absorbing apparatus 24 is made of a continuous seamless stainless steel plate, for example. In the case where the hard disk drive unit 22 has a weight between 80 g and 10 g approximately, the stainless steel plate may have a thickness in a range from 0.2 mm to 0.4 mm approximately, for example. The other metallic material such as an aluminum plate or a plate made of resin may be utilized to form the shock absorbing apparatus 24. The shock absorbing apparatus 24 may employ any types of plate having a predetermined thickness and elasticity as described later in detail. Otherwise, the shock absorbing apparatus 24 may employ a metallic wire material in place of the metallic plate material. The shock absorbing apparatus 24 needs not be made of a single material in the aforementioned manner.

As shown in FIG. 3, the shock absorbing apparatus 24 is assembled into the receiving space 18 along with the hard disk drive unit 22. When the cover 21 closes the opening of the receiving space 18, the enclosure body 19 and the cover 21 cooperate to completely surround the hard disk drive unit 22 and the shock absorbing apparatus 24 together. The hard disk drive unit 22 includes a recording medium or magnetic recording disk extending in the horizontal direction HR, a magnetic head opposed to the front and back surfaces of the magnetic recording disk, and other various components, all not shown, as conventionally known.

The shock absorbing apparatus 24 has a pair of front contact region 25a, 25b contacting the outer surface of the hard disk drive unit 22 for relative movement at the front or upper side of the hard disk drive unit 22, for example. The shock absorbing apparatus 24 likewise has a pair of back contact region 26a, 26b contacting the outer surface of the hard disk drive unit 22 for relative movement at the back or lower side of the hard disk drive unit 22. The hard disk drive unit 22 is interposed between the front contact regions 25a, 25b and the back contact regions 26a, 26b. The front and back contact regions 25a, 25b, 26a, 26b serve as contact members of the present invention. As is apparent from FIG. 2, the front and back contact regions 25a, 25b, 26a, 26b are allowed to uniformly contact the hard disk drive unit 22 along the longitudinal direction LDR of the hard disk drive unit 22.

The shock absorbing apparatus 24 also has first and second slide regions 27, 28 located outside the front contact regions 25a, 25b. The first and second slide regions 27, 28 are spaced from the front outer surface of the hard disk drive unit 22. The first and second slide regions 27, 28 are allowed to contact the inner surface of the enclosure body 19 for sliding movement. A first elastic region 29 extends from the front contact region 25a in a first direction DR1. The first elastic region 29 serves to connect the first slide region 27 to the front contact region 25a. A second elastic region 31 extends from the front contact region 25b in a second direction DR2 opposite to the first direction DR1. The second elastic region 31 serves to connect the second slide region 28 to the front contact region 25b. The slide regions 27, 28 serve as slide members of the present invention. The elastic regions 29, 31 serve as elastic members of the present invention. The first and second slide regions 27, 28 are allowed to uniformly contact the enclosure body 19 in the longitudinal direction LDR of the hard disk drive unit 22.

A first auxiliary slide region 32 is defined in the shock absorbing apparatus 24 between the front contact regions 25a, 25b at a position spaced from the outer surface of the hard disk drive unit 22. The first auxiliary slide region 32 is allowed to contact the inner surface of the enclosure body 19 for sliding movement. A first auxiliary elastic region 33 is formed to extend from the front contact region 25a in the second direction DR2 so as to connect the first auxiliary slide region 32 to the front contact region 25a. A second auxiliary elastic region 34 is formed to extend from the front contact region 25b in the first direction DR1 so as to connect the first auxiliary slide region 32 to the front contact region 25b.

The first elastic region 29 and the first auxiliary elastic region 33 exhibit a perpendicular elasticity distancing the front contact region 25a from the inner surface of the enclosure body 19. Accordingly, the front contact region 25a is urged against the outer surface of the hard disk drive unit 22. Moreover, the first elastic region 29 exhibits a parallel elasticity approximating the first slide region 27 toward the front contact region 25a. The first auxiliary elastic region 33 exhibits a parallel elasticity approximating the first auxiliary slide region 32 toward the front contact region 25a. The first elastic region 29 and the first auxiliary elastic region 33 may have a curved cross-section swelling toward the hard disk drive unit 22 from the inner surface of the enclosure body 19 so as to establish the aforementioned perpendicular and parallel elasticity, for example. The curved cross-section may be kept in the longitudinal direction LDR of the hard disk drive unit 22.

The second elastic region 31 and the second auxiliary elastic region 34 likewise exhibit a perpendicular elasticity distancing the front contact region 25b from the inner surface of the enclosure body 19. The front contact region 25b is thus urged against the outer surface of the hard disk drive unit 22. Moreover, the second elastic region 31 exhibits a parallel elasticity approximating the second slide region 28 toward the front contact region 25b. The second auxiliary elastic region 34 exhibits a parallel elasticity approximating the first auxiliary slide region 32 toward the front contact region 25b. The second elastic region 31 and the second auxiliary elastic region 34 may have a curved cross-section swelling toward the hard disk drive unit 22 from the inner surface of the enclosure body 19 so as to establish the aforementioned perpendicular and parallel elasticity, for example. The curved cross-section may be kept in the longitudinal direction LDR of the hard disk drive unit 22.

The shock absorbing apparatus 24 also has third and fourth slide regions 36, 37 located outside the back contact regions 26a, 26b. The third and fourth slide regions 36, 37 are spaced from the back outer surface of the hard disk drive unit 22. The third and fourth slide regions 36, 37 are allowed to contact the inner surface of the cover 21 for sliding movement. A third elastic region 38 extends from the back contact region 26a in the first direction DR1. The third elastic region 38 serves to connect the third slide region 36 to the back contact region 26a. A fourth elastic region 39 extends from the back contact region 26b in the second direction DR2. The fourth elastic region 39 serves to connect the fourth slide region 37 to the back contact region 26b. The slide regions 36, 37 serve as slide members of the present invention. The elastic regions 38, 39 serve as elastic members of the present invention. The third and fourth slide regions 36, 37 are allowed to uniformly contact the cover 21 in the longitudinal direction LDR of the hard disk drive unit 22.

A second auxiliary slide region 41 is defined in the shock absorbing apparatus 24 between the back contact regions 26a, 26b at a position spaced from the outer surface of the hard disk drive unit 22. The second auxiliary slide region 41 is allowed to contact the inner surface of the cover 21 for sliding movement. A third auxiliary elastic region 42 is formed to extend from the back contact region 26a in the second direction DR2 so as to connect the second auxiliary slide region 41 to the back contact region 26a. A fourth auxiliary elastic region 43 is formed to extend from the back contact region 26b in the first direction DR1 so as to connect the second auxiliary slide region 41 to the back contact region 26b.

The third elastic region 38 and the third auxiliary elastic region 42 exhibit a perpendicular elasticity distancing the back contact region 26a from the inner surface of the cover 21. Accordingly, the back contact region 26a is urged against the outer surface of the hard disk drive unit 22. Moreover, the third elastic region 38 exhibits a parallel elasticity approximating the third slide region 36 toward the back contact region 26a. The third auxiliary elastic region 42 exhibits a parallel elasticity approximating the second auxiliary slide region 41 toward the back contact region 26a. The third elastic region 38 and the third auxiliary elastic region 42 may have a curved cross-section swelling toward the hard disk drive unit 22 from the inner surface of the cover 21 so as to establish the aforementioned perpendicular and parallel elasticity, for example. The curved cross-section may be kept in the longitudinal direction LDR of the hard disk drive unit 22.

The fourth elastic region 39 and the fourth auxiliary elastic region 43 likewise exhibit a perpendicular elasticity distancing the back contact region 26b from the inner surface of the cover 21. The back contact region 26b is thus urged against the outer surface of the hard disk drive unit 22. Moreover, the fourth elastic region 39 exhibits a parallel elasticity approximating the fourth slide region 37 toward the back contact region 26b. The fourth auxiliary elastic region 43 exhibits a parallel elasticity approximating the second auxiliary slide region 41 toward the back contact region 26b. The fourth elastic region 39 and the fourth auxiliary elastic region 43 may have a curved cross-section swelling toward the hard disk drive unit 22 from the inner surface of the cover 21 so as to establish the aforementioned perpendicular and parallel elasticity, for example. The curved cross-section may be kept in the longitudinal direction LDR of the hard disk drive unit 22.

Furthermore, the shock absorbing apparatus 24 has a first coupling region 45 coupling the first and third slide regions 27, 36 with each other. A first side contact region 46 is defined in the first coupling region 45. The first side contact region 46 is allowed to contact the side surface of the hard disk drive unit 22 for relative movement, for example. The side surface may be defined along a vertical plane perpendicular to the upper and lower outer surfaces in the hard disk drive unit 22, for example. The first side contact region 46 may serve as a contact member of the present invention. The first side contact region 46 may uniformly contact the hard disk drive unit 22 in the longitudinal direction LDR of the hard disk drive unit 22.

A fifth slide region 47 is defined in the first coupling region 45 between the first side contact region 46 and the first slide region 27 at a location spaced from the side surface of the hard disk drive unit 22. A sixth slide region 48 is likewise defined in the first coupling region 45 between the first side contact region 46 and the third slide region 36 at a location spaced from the side surface of the hard disk drive unit 22. The fifth and sixth slide regions 47, 48 are allowed to contact the inner surface of the enclosure body 19 for sliding movement. An elastic region 49 is defined to extend from the first side contact region 46 in a third direction DR3 so as to connect the fifth slide region 47 to the first side contact region 46. An elastic region 51 is defined to extend from the first side contact region 46 in a fourth direction DR4 opposite to the third direction DR3 so as to connect the sixth slide region 48 to the first side contact region 46. The third and fourth directions DR3, DR4 may be defined in a plane perpendicular to a plane including the first and second directions DR1, DR2. The slide regions 47, 48 may serve as slide members of the present invention. The elastic regions 49, 51 may serve as elastic members of the present invention. The fifth and sixth slide regions 47, 48 may uniformly contact the enclosure body 19 in the longitudinal direction LDR of the hard disk drive unit 22.

The elastic regions 49, 51 exhibit a horizontal elasticity distancing the first side contact region 46 from the inner surface of the enclosure body 19. The first side contact region 46 is thus urged against the outer surface of the hard disk drive unit 22. Moreover, the elastic regions 49, 51 also exhibit a vertical elasticity approximating the fifth and sixth slide regions 47, 48 toward each other. The elastic regions 49, 51 may have a curved cross-section swelling toward the hard disk drive unit 22 from the inner surface of the enclosure body 19 so as to establish the aforementioned horizontal and vertical elasticity, for example. The curved cross-section may be kept in the longitudinal direction LDR of the hard disk drive unit 22.

The first coupling region 45 includes a driving force transmitting region 52 connecting the first and fifth slide regions 27, 47 to each other. A driving force transmitting region 53 is likewise employed to connect the third and sixth slide regions 36, 48. The driving force transmitting regions 52, 53 may have a sufficient rigidity, for example.

The shock absorbing apparatus 24 also has a second coupling region 55 coupling the second and fourth slide regions 28, 37 with each other. A second side contact region 56 is defined in the second coupling region 55. The second side contact region 56 is allowed to contact the side surface of the hard disk drive unit 22 for relative movement, for example. The side surface may be defined along a vertical plane parallel to the side surface receiving the aforementioned first side contact region 46 in the hard disk drive unit 22. The hard disk drive unit 22 is thus interposed between the first and second side contact regions 46, 56. The second side contact region 56 may serve as a contact member of the present invention. The second side contact region 56 may uniformly contact the hard disk drive unit 22 in the longitudinal direction LDR of the hard disk drive unit 22.

A seventh slide region 57 is defined in the second coupling region 55 between the second side contact region 56 and the second slide region 28 at a location spaced from the side surface of the hard disk drive unit 22. A eighth slide region 58 is likewise defined in the second coupling region 55 between the second side contact region 56 and the fourth slide region 37 at a location spaced from the side surface of the hard disk drive unit 22. The seventh and eighth slide regions 57, 58 are allowed to contact the inner surface of the enclosure body 19 for sliding movement. An elastic region 59 is defined to extend from the second side contact region 56 in the third direction DR3 so as to connect the seventh slide region 57 to the second side contact region 56. An elastic region 61 is defined to extend from the second side contact region 56 in the fourth direction DR4 so as to connect the eighth slide region 58 to the second side contact region 56. The slide regions 57, 58 may serve as slide members of the present invention. The elastic regions 59, 61 may serve as elastic members of the present invention. The seventh and eighth slide regions 57, 58 may uniformly contact the enclosure body 19 in the longitudinal direction LDR of the hard disk drive unit 22.

The elastic regions 59, 61 exhibit a horizontal elasticity distancing the second side contact region 56 from the inner surface of the enclosure body 19. The second side contact region 56 is thus urged against the outer surface of the hard disk drive unit 22. Moreover, the elastic regions 59, 61 also exhibit a vertical elasticity approximating the seventh and eighth slide regions 57, 58 toward each other. The elastic regions 59, 61 may have a curved cross-section swelling toward the hard disk drive unit 22 from the inner surface of the enclosure body 19 so as to establish the aforementioned horizontal and vertical elasticity, for example. The curved cross-section may be kept in the longitudinal direction LDR of the hard disk drive unit 22.

The second coupling region 55 includes a driving force transmitting region 62 connecting the second and seventh slide regions 28, 57 to each other. A driving force transmitting region 63 is likewise employed to connect the fourth and eighth slide regions 37, 58. The driving force transmitting regions 62, 63 may have a sufficient rigidity, for example.

The shock absorbing apparatus 24 allows the disposition of the front contact regions 25a, 25b, the first and second elastic regions 29, 31 and the first and second auxiliary elastic regions 33, 34 between the upper outer surface of the hard disk drive unit 22 and the inner surface of the enclosure body 19 facing the upper outer surface of the hard disk drive unit 22. Likewise, the shock absorbing apparatus 24 allows the disposition of the back contact regions 26a, 26b, the third and fourth elastic regions 38, 39 and the third and fourth auxiliary elastic regions 42, 43 between the lower outer surface of the hard disk drive unit 22 and the inner surface of the cover 21 facing the lower outer surface of the hard disk drive unit 22. The hard disk drive unit 22 can be held within the receiving space 18 without contacting the upper and lower outer surfaces with the enclosure body 19 and the cover 21. When the perpendicular elasticity of the first and second elastic regions 29, 31 and the first and second auxiliary elastic regions 33, 34 is balanced with the perpendicular elasticity of the third and fourth elastic regions 38, 39 and the third and fourth auxiliary elastic regions 42, 43, the hard disk drive unit 22 is positioned in the vertical direction.

The shock absorbing apparatus 24 allows the disposition of the first side contact region 46 and the elastic regions 49, 51 between the side surface of the hard disk drive unit 22 and the inner surface of the enclosure body 19 facing the side surface of the hard disk drive unit 22. Likewise, the shock absorbing apparatus 24 allows the disposition of the second side contact region 56 and the elastic regions 59, 61 between the side surface of the hard disk drive unit 22 and the inner surface of the enclosure 19 facing the side surface of the hard disk drive unit 22. The hard disk drive unit 22 can be held within the receiving space 18 without contacting the side surfaces with the enclosure body 19. When the horizontal elasticity of the elastic regions 49, 51 is balanced with the horizontal elasticity of the elastic regions 59, 61, the hard disk drive unit 22 is positioned in the horizontal direction. The hard disk drive unit 22 is allowed to receive the elasticity of the shock absorbing apparatus 24 around the hard disk drive unit 22.

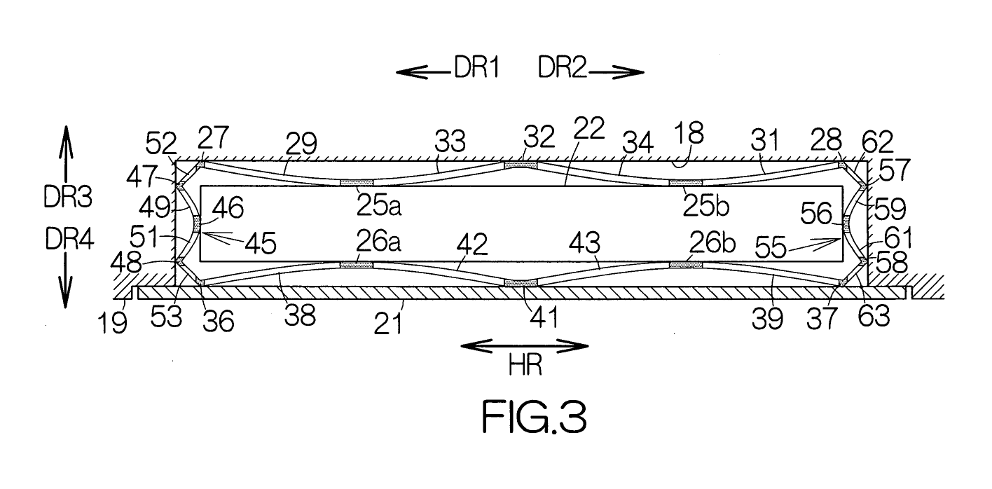

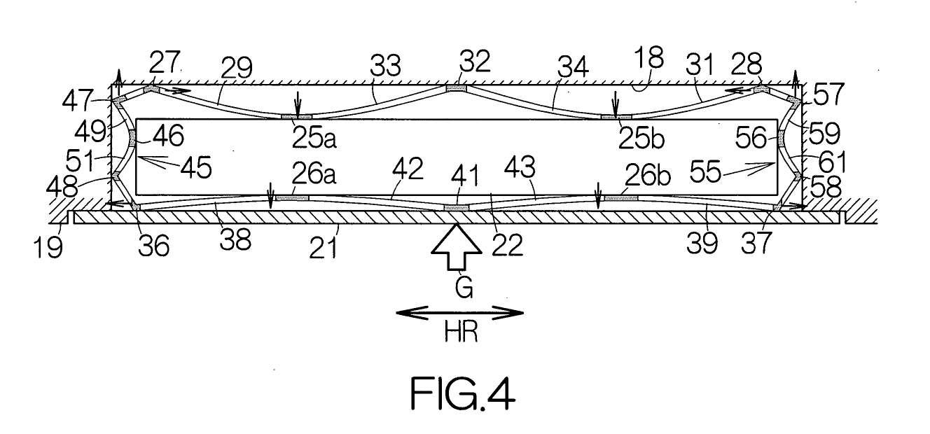

Now, assume that an impact G of 1.0-3.0 km/s² approximately acts on the main equipment 12 from the bottom, as shown in FIG. 4, for example. The reaction of the impact G drives the hard disk drive unit 22 toward the inner surface of the cover 21. Specifically, a space is reduced between the lower outer surface of the hard disk drive unit 22 and the cover 21. A leaf spring comprising the third elastic region 38 and the third auxiliary elastic region 42 is flattened. A leaf spring comprising the fourth elastic region 39 and the fourth auxiliary elastic region 43 is also flattened. The elastic deformation of the elastic regions 38, 39, 42, 43 serves to consume the kinetic energy of the impact G. The back contact regions 26a, 26b are displaced toward the cover 21. The back contact regions 26a, 26b keep contacting the hard disk drive unit 22 during the displacement.

The elastic deformation of the third elastic region 38 and the third auxiliary elastic region 42 causes the third slide region 36 to slide on the inner surface of the cover 21. The third slide region 36 moves away from the second auxiliary slide region 41. The elastic deformation of the fourth elastic region 39 and the fourth auxiliary elastic region 43 likewise causes the fourth slide region 37 to slide on the inner surface of the cover 21. The fourth slide region 37 moves away from the second auxiliary slide region 41. The movement of the third and fourth slide regions 36, 37 serves to consume the kinetic energy of the impact G. The kinetic energy of the impact G is also consumed in the friction during the movement of the third and fourth slide regions 36, 37.

The displacement of the third slide region 36 is transmitted to the first slide region 27 through the first coupling region 45. The kinetic energy of the impact G is consumed in the movement of the first side contact region 46 and the fifth and sixth slide regions 47, 48 as well as in the friction during the movement in the first coupling region 45. At the same time, the deformation of the elastic regions 49, 51 serves to consume the kinetic energy of the impact G. Likewise, the displacement of the fourth slide region 37 is transmitted to the second slide region 28 through the second coupling region 55. The kinetic energy of the impact G is consumed in the movement of the second side contact region 56 and the seventh and eighth slide regions 57, 58 as well as in the friction during the movement in the second coupling region 55. The deformation of the elastic regions 59, 61 also serves to consume the kinetic energy of the impact G.

The first slide region 27 receives the displacement of the third slide region 36 through the first coupling region 45. The first slide region 27 is allowed to slide on the inner surface of the enclosure body 19. The first slide region 27 thus gets closer to the first auxiliary slide region 32. Similarly, the second slide region 28 receives the displacement of the fourth slide region 37 through the second coupling region 55. The second slide region 28 is allowed to slide on the inner surface of the enclosure body 19. The second slide region 28 thus gets closer to the first auxiliary slide region 32. The kinetic energy of the impact G is in this manner consumed in the movement of the first and second slide regions 27, 28 as well as in the friction during the movement.

The first and second slide regions 27, 28 get closer to each other, so that the first elastic region 29 and the first auxiliary elastic region 33 are caused to elastically deform. The first elastic region 29 and the first auxiliary elastic region 33 serve to generate a driving force to distance the front contact region 25a from the inner surface of the enclosure body 19. Similarly, the second elastic region 31 and the second auxiliary elastic region 34 are caused to elastically deform. The second elastic region 31 and the second auxiliary elastic region 34 serve to generate a driving force to distance the front contact region 25b from the inner surface of the enclosure body 19. The front contact regions 25a, 25b follow the movement of the hard disk drive unit 22. The front contact regions 25a, 25b keep contacting the hard disk drive unit 22 irrespective of the displacement of the hard disk drive unit 22. The kinetic energy of the impact G is consumed in the elastic deformation of the elastic regions 29, 31, 33, 34. In this manner, the entire shock absorbing apparatus 24 serves to consume the kinetic energy of the impact G, so that the impact is remarkably attenuated in a shorter duration before reaching the hard disk drive unit 22. The hard disk drive unit 22 is thus sufficiently protected from the impact G of a larger intensity.

When a larger impact G acts on the main equipment 12 from the front or upper side, the hard disk drive unit 22 is forced to move toward the ceiling of the receiving space 18, namely toward the enclosure body 19. A leaf spring comprising the first elastic region 29 and the first auxiliary elastic region 33 is flattened. The displacement of the first slide region 27 is transmitted to the third slide region 36 through the first coupling region 45. Similarly, a leaf spring comprising the second elastic region 31 and the second auxiliary elastic region 34 is flattened. The displacement of the second slide region 28 is transmitted to the fourth slide region 37 through the second coupling region 55. The third and fourth slide regions 36, 37 in this manner get closer to each other. The third and fourth elastic regions 38, 39 and the third and fourth auxiliary elastic regions 42, 43 are caused to elastically deform. The entire shock absorbing apparatus 24 in this manner serves to consume the kinetic energy of the impact G. The impact is remarkably attenuated in a shorter duration before reaching the hard disk drive unit 22.

When a larger impact G acts on the side surface of the main equipment 12, the impact G serves to drive the hard disk drive unit 22 in the horizontal direction HR. This horizontal displacement induces an elastic deformation of the elastic regions 49, 51 and the elastic regions 59, 61. The displacement of the front contact regions 25a, 25b and the slide regions 27, 28, 32 as well as the elastic deformation of the elastic regions 29, 31, 33, 34 serve to relate the fifth and seventh slide regions 47, 57 with each other when the fifth or seventh slide region 47, 57 displaces. Likewise, the displacement of the back contact regions 26a, 26b and the slide regions 36, 37, 41 as well as the elastic deformation of the elastic regions 38, 39, 42, 43 serve to relate the sixth and eighth slide regions 48, 58 with each other when the sixth or eighth slide region 48, 58 displaces. In this manner, the entire shock absorbing apparatus 24 serves to consume the kinetic energy of the impact G of a larger intensity in the same manner as described above. The impact is thus remarkably attenuated in a shorter duration before reaching the hard disk drive unit 22.

The inventors have examined the performance of the shock absorbing apparatus 24 based on a computer-implemented simulation. As shown in FIG. 5, the inventors prepared a half exemplified model 72 of the shock absorbing apparatus 24. The plane of symmetry 71 was utilized to define the half exemplified model 72. A space was set at 12.0 mm between the inner surface of the enclosure body 19 and the inner surface of the cover 21. The shock absorbing apparatus 24 was assembled into the receiving space 18. The distance was set at 2.0 mm between the front contact region 25b of the shock absorbing apparatus 24 and the inner surface of the enclosure body 19 when no load was applied to the shock absorbing apparatus 24. The distance was likewise set at 2.0 mm between the back contact region 26b and the inner surface of the cover 21. The hard disk drive unit 22 having the height of 8.4 mm was placed within the shock absorbing apparatus 24. The distance was thus reduced to 1.8 mm between the front contact region 25b and the inner surface of the enclosure body 19 as well as between the back contact region 26b and the inner surface of the cover 21. The elasticity was thus stored in the elastic regions 31, 34, 39, 43.

An impact G was applied to the main equipment 12 from the bottom in the vertical direction in the computer-implemented simulation. The acceleration of the hard disk drive unit 22 was calculated at an observation point 73 set on the plane of symmetry 71. As shown in FIG. 6, the impact G was set to establish a sine wave having the amplitude of 6.0 km/s². The period of the sine wave was set at 2 ms. As is apparent from FIG. 6, the amplitude of the acceleration was remarkably reduced at the observation point, namely at the hard disk drive unit 22. It has been proven that the shock absorbing apparatus 24 sufficiently protects the hard disk drive unit 22 even when the impact G of a larger intensity is applied to the shock absorbing apparatus 24.

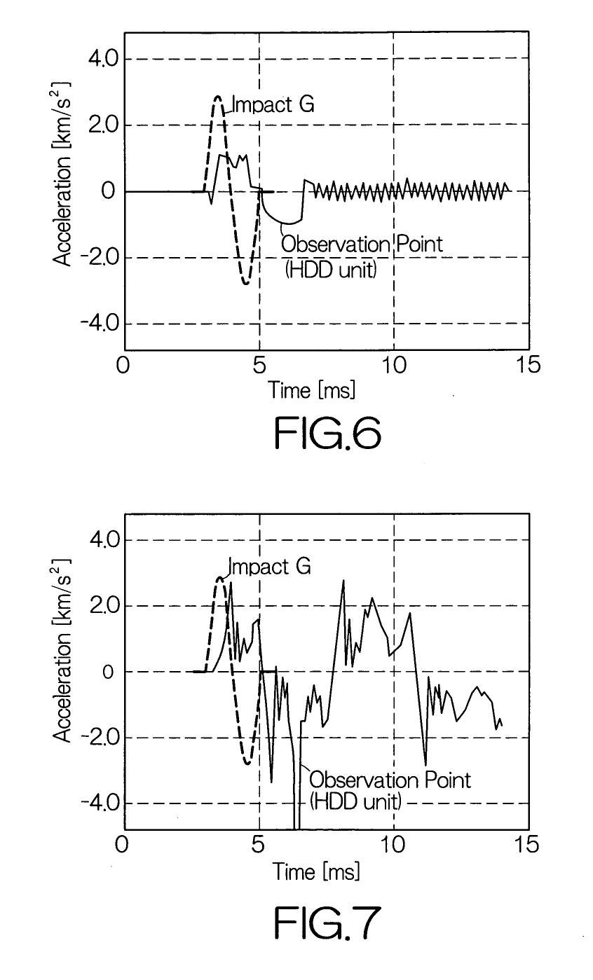

The inventors also prepared a first comparative model in the examination. The first comparative model included the shock absorbing apparatus 24 and the hard disk drive unit 22 within the receiving space 18 in the same manner as the exemplified model 72. Here, the slide regions 28, 32, 37, 41, 57, 58 of the shock absorbing apparatus 24 were fixed to the enclosure body 19 and the cover 21 in the first comparative model. The movement of the slide regions 28, 32, 37, 41, 57, 58 was restrained in the first comparative model. The impact G was set to establish a sine wave having the amplitude of 6.0 km/s² in the same manner as the exemplified model. As shown in FIG. 7, no reduction could at all be observed in the amplitude of the acceleration for the first comparative model.

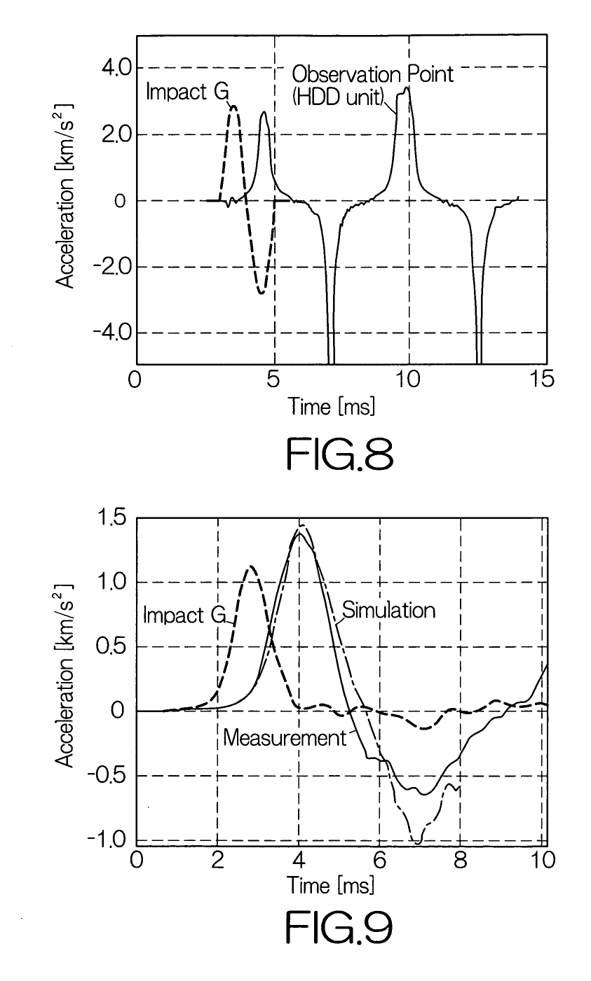

Likewise, the inventors also prepared a second comparative model in the examination. The second comparative model included the shock absorbing apparatus 24 and the hard disk drive unit 22 within the receiving space 18 in the same manner as the exemplified model 72. Here, the driving force transmitting regions 62, 63 were completely cut off in the second comparative model. Specifically, the connection was released between the second and seventh slide regions 28, 57 as well as between the fourth and eighth slide regions 37, 58. The impact G was set to establish a sine wave having the amplitude of 6.0 km/s² in the same manner as the exemplified model. As shown in FIG. 8, no reduction could at all be observed in the amplitude of the acceleration for the second comparative model.

At the same time, the inventors have examined the accuracy of the computer-implemented simulation. The acceleration of the hard disk drive unit 22 was measured in predetermined conditions. A shock absorbing member made of rubber was adhered to the outer surface of the hard disk drive unit 22. The shock absorbing member had the thickness of 2.0 mm approximately. The hard disk drive unit 22 is placed within the receiving space 18. A model of the hard disk drive unit 22 was constructed in the computer-implemented simulation. The same conditions were established for the model of the hard disk drive unit 22 in the computer-implemented simulation. The impact G of the actual measurement was created for the model of the hard disk drive unit 22 in the computer-implemented simulation. As is apparent from FIG. 9, it has been proven that the acceleration of the hard disk drive unit 22 is created with a higher accuracy in the computer-implemented simulation.

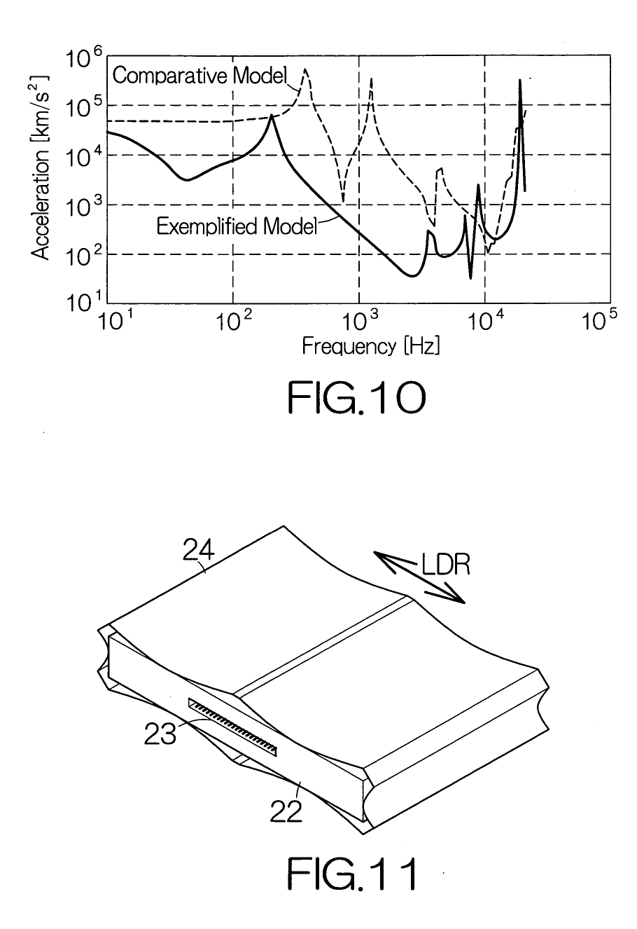

Furthermore, the inventors have examined the vibration characteristic of the shock absorbing apparatus 24 based on a computer-implemented simulation. The inventors utilized the aforementioned half exemplified model and the first comparative model. Vibration was applied to the models in the vertical direction based on a sine wave having the amplitude of 5.0 m/s². As is apparent from FIG. 10, it has been proved that the vibration is remarkably suppressed in the exemplified model 72 as compared with the first comparative model over a practical frequency band range ranging from 500 Hz to 1,000 Hz

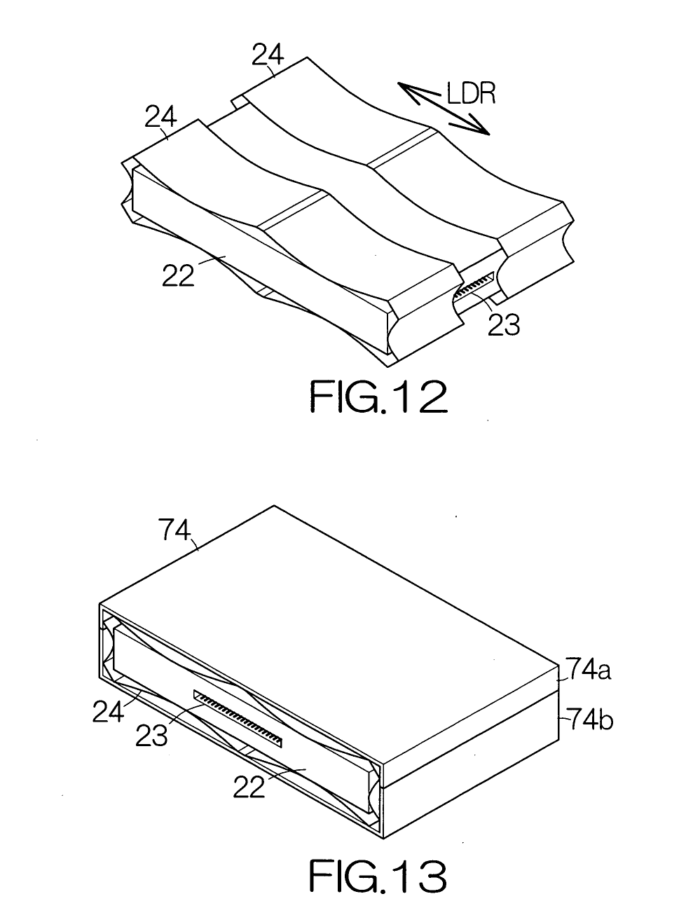

Various modifications may be proposed for the aforementioned shock absorbing apparatus 24. For example, the shock absorbing apparatus 24 may surround the front and back outer surfaces and the front and back ends of the hard disk drive unit 22, as shown in FIG. 11. In this case, the side surfaces of the hard disk drive unit 22 are exposed outside. A predetermined connector 23 may be mounted on the exposed side surface. Otherwise, a pair of the shock absorbing apparatus 24 may be attached to the hard disk drive unit 22, as shown in FIG. 12. In this case, the front end of the hard disk drive unit 22 can be exposed between the shock absorbing apparatuses 24, 24. The connector 23 can be located at the exposed front end of the hard disk drive unit 22. Additionally, the shock absorbing apparatus 24 may be contained within a unique enclosure 74, as shown in FIG. 13. The unique enclosure 74 serves to establish an assembly including the shock absorbing apparatus 24 and the hard disk drive unit 22. Easy handling can be realized. The unique enclosure 74 may include an upper half shell 74a and a lower half shell 74b coupled to the upper half shell 74a, for example.

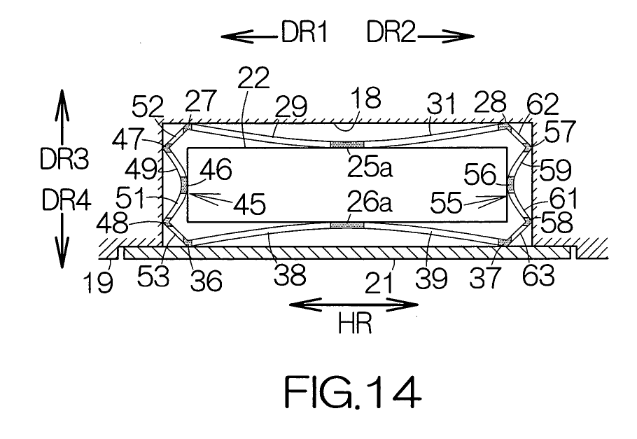

In the case where the shock absorbing apparatus 24 has symmetry relative to a predetermined plane of symmetry as described above, the first and second auxiliary slide regions 32, 41 on the plane of symmetry may be fixed to the enclosure body 19 or the cover 21. In any cases, the shock absorbing apparatus 24 may include a single front contact region 25a and a single back contact region 26a, as shown in FIG. 14. In this case, the front contact region 25a and/or the back contact region 26a on the plane of symmetry may be fixed to the hard disk drive unit 22.

The shock absorbing apparatus 24 may be utilized not only for the hard disk drive unit 22 in the notebook personal computer 11 as described above, but also in any type of internal unit in an electronic apparatus. Additionally, the shock absorbing apparatus 24 may be utilized in any other equipment other than the electronic apparatus.

1. A shock absorbing apparatus for an internal unit, comprising:
first and second contact members holding the internal unit therebetween;
a first slide member located at a position spaced from an outer surface of the internal unit, said first slide member coupled to the first contact member through a first elastic member;
a second slide member located at a position spaced from the outer surface of the internal unit, said second slide member coupled to the second contact member through a second elastic member; and
a coupling member coupling the first and second slide members with each other.

2. The shock absorbing apparatus according to claim 1, wherein the first and second contact members, the first and second elastic members, the first and second slide members and the coupling member are formed from a common material.

3. The shock absorbing apparatus according to claim 1, wherein the first and second contact members, the first and second elastic members, the first and second slide members and the coupling member are designed to cooperate to surround the internal unit.

4. The shock absorbing apparatus according to claim 3, wherein the first and second contact members, the first and second elastic members, the first and second slide members and the coupling member are made of a continuous metallic plate.

5. A shock absorbing apparatus for an internal unit, comprising:
an enclosure containing the internal unit;
first and second contact members holding the internal unit therebetween in the enclosure;
a first slide member contacting an inner surface of the enclosure at a position spaced from an outer surface of the internal unit for sliding movement, said first slide member coupled to the first contact member through a first elastic member;
a second slide member contacting the inner surface of the enclosure at a position spaced from the outer surface of the internal unit for sliding movement, said second slide member coupled to the second contact member through a second elastic member; and
a coupling member coupling the first and second slide members with each other.

6. The shock absorbing apparatus according to claim 5, wherein the first and second contact members, the first and second elastic members, the first and second slide members and the coupling member are formed from a common material.

7. The shock absorbing apparatus according to claim 5, wherein the first and second contact members, the first and second elastic members, the first and second slide members and the coupling member are designed to cooperate to surround the internal unit.

8. The shock absorbing apparatus according to claim 7, wherein the first and second contact members, the first and second elastic members, the first and second slide members and the coupling member are made of a continuous metallic plate.

9. A shock absorbing apparatus for an internal unit, comprising:
first and second contact members holding the internal unit therebetween;
a first elastic member extending from the first contact member in a first direction;
a first slide member located at a position spaced from an outer surface of the internal unit, said first slide member coupled to the first elastic member;
a second elastic member extending from the first contact member in a second direction opposite to the first direction;
a second slide member located at a position spaced from the outer surface of the internal unit, said second slide member coupled to the second elastic member;
a third elastic member extending from the second contact member in the first direction;
a third slide member located at a position spaced from the outer surface of the internal unit, said third slide member coupled to the third elastic member;
a fourth elastic member extending from the second contact member in the second direction;
a fourth slide member located at a position spaced from the outer surface of the internal unit, said fourth slide member coupled to the fourth elastic member;
a first coupling member coupling the first and third slide members with each other; and
a second coupling member coupling the second and fourth slide members with each other.

10. The shock absorbing apparatus according to claim 9, wherein the first and second contact members, the first, second, third and fourth elastic members, the first, second, third and fourth slide members and the first and second coupling members are formed from a common material.

11. The shock absorbing apparatus according to claim 9, wherein the first and second contact members, the first, second, third and fourth elastic members, the first, second, third and fourth slide members and the first and second coupling members are designed to cooperate to surround the internal unit.

12. The shock absorbing apparatus according to claim 11, wherein the first and second contact members, the first, second, third and fourth elastic members, the first, second, third and fourth slide members and the first and second coupling members are made of a continuous metallic plate.
